(19) United States
(12) Patent Application Publication
(10) Pub. No.: US 2002/0046612 A1
(43) Pub. Date: Apr. 25, 2002

(54) Fluid mass flow meter with substantial measurement range

(75) Inventor: Daniel T. Mudd, St. Charles, MO (US)

Correspondence Address: RANDALL C BROWN, AKIN GUMP STRAUSS HAUER & FELD, P O BOX 688, DALLAS, TX, 75313

(73) Assignee: FuGasity Corporation, Sparks, NV

(21) Appl. No.: 09/934,724

(22) Filed: Aug. 21, 2001

Related U.S. Application Data
(60) Provisional application No. 60/226,806, filed on Aug. 22, 2000.

(51) Int. Cl. G01F 1/37

(52) U.S. Cl. 73/861.52

(57) ABSTRACT

Fluid mass flow meters, particularly for measuring a wide range of relatively low flow rates of gas used in semiconductor fabrication processes include a body adapted to be interposed in a purge gas line leading to or from a mass flow controller or in a process gas line with the mass flow controller. The flow meter body includes a flow restrictor interposed in a passage and plural mass flow sensors which sense overlapping full scale fluid mass flow ranges across the flow restrictor to increase the overall range of fluid mass flow rates sensed by the meter. The flow meter body may include series or parallel arranged flow restrictors, a second set of mass flow sensors, and valving to cause a set of mass flow sensors to sense fluid mass flow rates across one or both of the flow restrictors. Embodiments of the flow meter include a pressure transducer mass flow sensor and conduits arranged with additional flow restrictors therein to selectively vary the full scale measurement range of the mass flow sensor.

### CROSS REFERENCE TO RELATED APPLICATION

This application claims the priority of U.S. Provisional Patent Application 60/226,806, filed Aug. 22, 2000.

### BACKGROUND

Many applications of fluid mass flow devices, including fluid mass flow meters and calibration tools require a relatively large range of flow measurement capability at relatively low overall flow rates. For example, in the control of flow of gases used in the fabrication of semiconductor devices, the accuracy of the mass flow controllers must be verified repeatedly over a wide range of relatively low flow rates of gas, since the quantities of such gases directly affect the chemical and physical properties of the semiconductor devices being fabricated. Accordingly, substantially continuous or very frequent monitoring of fluid mass flow controllers is advantageous to avoid delivering gas flows to semiconductor fabrication processes at incorrect flow rates.

A significant number of gases used in semiconductor fabrication processes are corrosive, pyrophoric or poisonous, or a combination of all such characteristics. The gas delivery apparatus may have multiple gas lines or conduits, each containing a mass flow controller connected to a process vessel. A source of an inert gas, such as nitrogen, is typically provided for purging the flow conduits and controllers for the various gases from time to time, to change the gas being controlled or to allow replacement or repair of the fluid mass flow controllers associated with the fabrication system or process.

Due to the criticality of maintaining accuracy of gas flow rates used in semiconductor manufacturing, in particular, it is desirable to provide calibration devices, such as so-called rate of rise systems or mass flow meters to monitor the flow rates being controlled by mass flow controllers. Typically, in prior art arrangements, calibration devices or flow meters have been placed in series with each mass flow controller device, thereby complicating the overall system. Moreover, due to the wide range of full scale flow rates that fluid mass flow controllers are required to accommodate, the use of a single conventional mass flow meter as a reference for all mass flow controllers has required that the mass flow meter operate over a wider dynamic range than it is capable of maintaining for the required accuracy of flow measurements. The needed one percent of reading flow accuracy specification for most semiconductor fabrication processes is unattainable by conventional mass flow meters over the full scale operating range required.

The inherent design of commercially available mass flow controller sensors contains an error component that is proportional to the full scale flow of a device. For example, a 1000 sccm (standard cubic centimeters per minute) controller that has a 0.5 percent full scale accuracy is not capable of accurate measurement at a flow rate of 50 sccm wherein the accuracy becomes 10 percent of the 50 sccm reading. However, by providing multiple full scale ranges in a device wherein parallel sensors are provided which reach full scale excitation at markedly different pressure drops across a common laminar flow element or flow restrictor and by providing one sensor to overlap the range of another, a wide dynamic range is provided and which is one improvement in accordance with the present invention.

Moreover, a so called pneumatic lag error occurs when gas flowing through a mass flow meter causes a pressure loss or so called pressure drop. The magnitude of this error as a percent of full scale flow of the meter is directly proportional to the magnitude of the pressure drop and the gas accumulation volume between the mass flow meter and the mass flow controller. At moderate flow rates this error is small and short lived. However, at low flow rates the error can be significant. For example, measuring flow rates as low as 10 sccm, using conventional commercially available flow meters, such as MOLBLOC brand gas flow calibration systems available from DH Instruments, Inc., which experience differential pressures as high as 7.0 psi, may take as much as fifteen minutes to complete. However, by utilizing a sensor which has a very small pressure drop (0.001 psi) the magnitude of the pneumatic lag may be reduced substantially.

Another problem associated with fluid mass flow calibration devices or meters is related to changes in either the electronic characteristics, the fluid system of the device or the heat transfer system of the device, any of which will result in a calibration shift. However, sensor and electronic drift on one instrument set may be detected by comparing its flow data to data from an instrument set whose flow range is directly above and/or below the instrument set in question. Still further, errors in mass flow control due to clogging of the flow passages by unwanted material can be detected by using flow restrictors or laminar flow elements which have markedly different hydraulic diameters thereby exhibiting different propensities to clogging. Moreover, such errors can also be detected by comparing data of one instrument set with another and knowing the relative hydraulic diameters of the laminar flow elements of each instrument set. The problems associated with prior art mass flow control calibration and measurement described above have been overcome by the present invention.

### SUMMARY OF THE INVENTION

The present invention provides an improved fluid mass flow meter, particularly adapted for measuring a wide range of fluid mass flow rates in processes including, in particular, processes requiring precise gaseous mass flow rates in semiconductor fabrication, for example.

In accordance with one aspect of the present invention an improved fluid mass flow meter is provided which is preferably disposed in a supply conduit for an inert gas used to purge process gases from multiple mass flow controllers flowing gases into the chambers of a semiconductor process apparatus. The improved mass flow meter can thus be valved in series with each individual mass flow controller and used as a reference to detect a calibration shift in a mass flow controller when operating on the inert gas. Such operation can be indicative of a calibration shift on any of the process gases which might be controlled by the mass flow controller during a working process. At least certain embodiments of the invention are also operable to be placed in line with the mass flow controller(s) for measuring the process gases directly.

In accordance with another aspect of the present invention. A fluid mass flow meter is provided which is operable to route the same gas flow through different flow measuring devices. In one embodiment of the invention a mass flow meter is provided which is operable to serially flow fluid through two flow restrictors. Moreover, the mass flow meter includes duplicate sets of mass flow sensors arranged in parallel across each flow restrictor.

In accordance with another embodiment of the invention a mass flow meter is provided wherein fluid flow is directed through a first flow restrictor and then subsequently through a second flow restrictor and wherein a single set of parallel arranged mass flow sensors is operable to sense flow through each restrictor currently receiving the flow.

In accordance with another aspect of the invention a fluid mass flow meter is provided which is arranged such that mass flow sensors are provided with individual operating ranges which overlap, but which ranges are markedly different and increase from a relatively low value to a relatively high value to allow an expanded measurement range. The invention also provides a mass flow meter wherein a flow restrictor or laminar flow element and associated mass flow sensors generate markedly different pressure drops when flowing the same quantity of fluid. The flow restrictors of the different mass flow sensors are sized such that the magnitude of the pressure drop resulting from a flow through the sensor that produces a full scale output signal is markedly different.

In accordance with still a further aspect of the invention, fluid mass flow meters are provided wherein the degree of overlap between the flow ranges of the flow sensors is sufficient to allow multiple measurements to be taken concurrently. Comparisons of the concurrent readings may be used to generate an alarm signal should one of the independent sensors provide signals which deviate from another sensor. By providing an arrangement wherein two laminar flow elements or flow restrictors and three different sensors are used in the mass flow meter, six different operating ranges are provided resulting in a very wide range of full scale flow measurement capability.

Still further, the present invention provides a method wherein calibration verification for fluid mass flow controllers installed in semiconductor fabrication process apparatus may be provided. However, the wide dynamic range mass flow meter of the invention may be used in other applications.

Although preferred embodiments of the invention are described herein those skilled in the art will further appreciate the above noted advantages and features of the invention together with other important aspects thereof upon reading the detailed description which follows in conjunction with the drawings.

### BRIEF DESCRIPTION OF THE SEVERAL VIEWS OF THE DRAWINGS

FIG. 1 is a schematic diagram of one preferred embodiment of a primarily thermal sensor based fluid mass flow meter in accordance with the invention;

FIG. 2 is a schematic diagram of another preferred embodiment of a thermal sensor based mass flow meter in accordance with the invention;

FIG. 3 is a schematic diagram of another preferred embodiment of a thermal sensor based fluid mass flow meter in accordance with the invention;

FIG. 4 is a schematic diagram of still another thermal sensor based fluid mass flow meter in accordance with the invention;

FIG. 5 is a schematic diagram of a preferred embodiment of a pressure sensor based fluid mass flow meter in accordance with the invention;

FIG. 6 is a schematic diagram of another preferred embodiment of a pressure sensor based fluid mass flow meter in accordance with the invention; and

FIG. 7 is a table of selected design features and exemplary full scale flow rates for certain embodiments of the present invention.

### DETAILED DESCRIPTION OF THE PREFERRED EMBODIMENTS

In the description which follows like elements are marked throughout the specification and drawing with the same reference numerals, respectively. The drawing FIGURES are generalized schematic diagrams in the interest of clarity and conciseness.

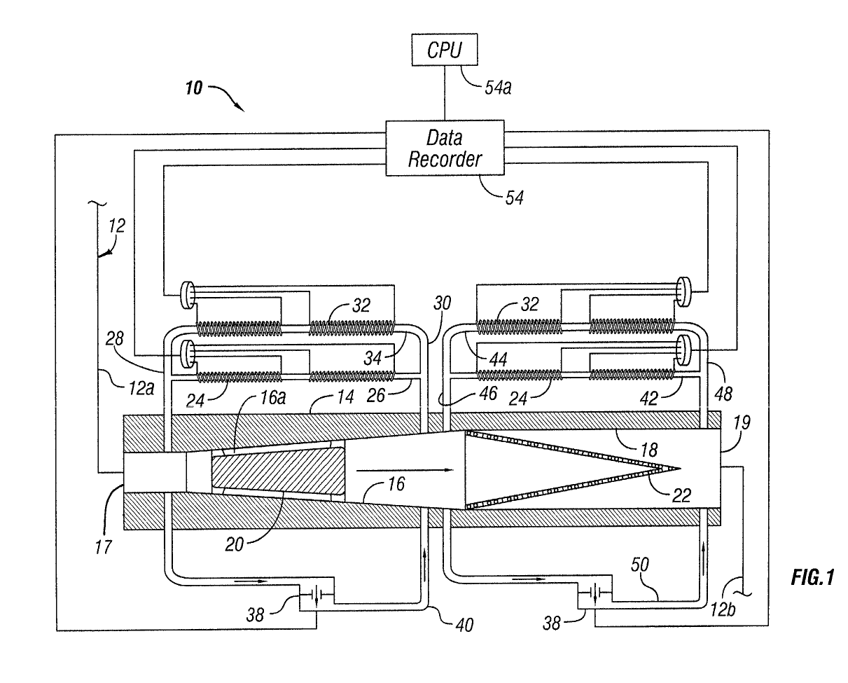

Referring to FIG. 1, there is illustrated a fluid mass flow meter in accordance with the invention and generally designated by the numeral 10. The fluid mass flow meter 10 is adapted to be interposed in a gas flow conduit 12 having a first section 12a and a second section 12b. Conduit section 12a is operable to be connected to a source of inert gas, not shown, such as nitrogen, for purging the flow conduits and mass flow controllers of a semiconductor fabrication process system. Discharge conduit 12b is operable to be connected to respective ones of the aforementioned mass flow controllers, not shown. Flow meter 10 includes a body 14 including a somewhat divergent flow passage 16 in communication with an inlet port 17 and with a substantially constant diameter continuing flow passage 18. Passage 18 is connected to conduit 12b at a discharge port 19. The flow meter 10 includes a first flow restrictor 20 disposed in passage 16. Flow restrictor 20 is characterized as a solid plug element supported in passage 16 in such a way as to provide a substantially annular flow passage 16a disposed about the outer circumference of the plug type flow restrictor 20 and delimited by the wall of passage 16. A second flow restrictor 22 is disposed in passage 18 and preferably comprises a generally conical shaped wire mesh element as shown schematically in FIG. 1 and throughout other figures of the drawings. Flow restrictors 20 and 22 may also be referred to herein as laminar flow elements (LFE) . Flow restrictors used with flow meters in accordance with the invention may not require to have an entirely linear performance characteristic over the entire range of their operation. However, flow restrictors which are characterized as laminar flow elements are generally preferred for use with the flow meters of the present invention. Various configurations of flow restrictors, some of which may be characterized as LFEs, may be used with the present invention including, for example, porous sintered metal plugs or plugs with multiple parallel conduits or flow passages formed therein. Other forms of flow restrictors or LFEs may also be used with the flow meters of the invention.

Mass flow meter 10 includes a first mass flow sensor 24 interposed in a conduit 26 connected to conduits 28 or 30 which are in communication with the passage 16 on opposite sides of the flow restrictor or LFE 20. A second mass flow sensor 32 is arranged in parallel with mass flow sensor 24 and includes a conduit 34 in flow communication with the conduits 28 and 30. Mass flow sensors 24 and 32 are arranged in parallel. Mass flow sensors 24 and 32 are of the thermal type and may be similar to the type described in my U.S. Pat. No. 5,660,207, issued Aug. 26, 1997. Also, the mass flow sensors 24 and 32 may be of a type manufactured by the Millipore Corp. as one of their FC 2900 Series sensors. Mass flow sensor 24 may have a conduit inner diameter of 0.010 inches, for example, for conduit section 26 and which generates a pressure drop of 3.0 inches of water (0.1 psi) when operating at a full scale condition on nitrogen gas at so-called typical room temperature and pressure. Mass flow sensor 32 may also be of the type described in my U.S. Pat. No. 5,660,207 or one of a type manufactured by Millipore Corp. as their model FC 490 series and includes a conduit section 34 having an inner diameter of 0.022 inches and operable to generate a pressure drop of 0.1 inches water (0.003 psi) when operating at full scale on nitrogen gas at typical room temperature and pressure. An additional flow restrictor may be placed in series with the mass flow sensor 32 to achieve a targeted 0.3 inches of water flow resistance.

Mass flow meter 10 includes a third fluid mass flow sensor 38 interposed in a conduit 40 in communication with the passage 16 across the flow restrictor or LFE 20, as indicated schematically in FIG. 1. Mass flow sensor 38 may be one of several types. One preferred type is a micromachined flow sensor available from Honeywell Inc., Freeport, Ill. as their model AWM42150VH. This sensor is rated at a full scale flow of 25 sccm which, beyond that point, significant non-linearity characteristics start to result from measuring mass flow. Another type of sensor which may be used is commercially available from Yamatake Corporation, Tokyo, Japan.

Still further, the mass flow meter 10 includes a second set of flow sensors 24 and 32 interposed in conduits 42 and 44, respectively, in communication with conduits 46 and 48 and in parallel flow arrangement. Sensors 24 and 32 of the second set are in fluid flow communication with passages 16, 18 across the flow restrictor or LFE 22, as shown by the schematic diagram of FIG. 1. A mass flow sensor 38 is interposed in a conduit 50 in communication with passages 16, 18 across the flow restrictor 22, as indicated in FIG. 1. Output signals from all of the mass flow sensors of the flow meter 10 may be carried to a suitable recording device 54 which may be connected to a digital processor or CPU 54a for processing and managing the recorded data from the sensors of the apparatus 10, FIG. 1, as indicated, for appropriate handling and recording. Flow sensor 38 provides the lowest flow restriction, on the order of 0.01 to 0.03 inches of water (0.0003 to 0.001 psi) and, as such, act as the primary references used for measuring lower flows. The flow restriction for the sensors 38 may be accomplished with the 0.060 inch internal diameter thermal sensor or the above identified sensor available from Honeywell Inc.

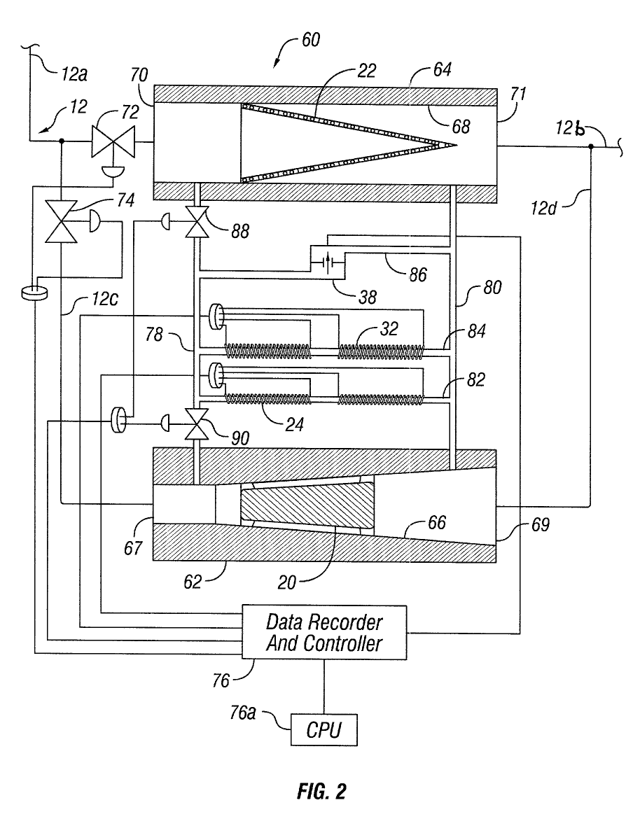

Referring now to FIG. 2, a first alternate embodiment of a flow meter in accordance with the invention is illustrated and generally designated by the numeral 60. The mass flow meter 60 is adapted to be interposed in conduit 12 in the same manner as the flow meter 10, as illustrated. Mass flow meter 60 includes bodies 62 and 64 having respective flow passages 66 and 68 formed therein and corresponding somewhat to the passages 16 and 18 of the embodiment of FIG. 1, respectively. Bodies 62 and 64 may be integrally joined. An LFE or flow restrictor 20 is interposed in passage 66 which is in communication with an inlet port 67 and a discharge port 69. Flow restrictor or LFE 22 is disposed in passage 68 which is in communication with an inlet port 70 and a discharge port 71. Flow meter body 62 is in fluid flow communication with conduits 12a and 12b through branch conduits 12c and 12d, respectively, as illustrated. A remotely controllable valve 72 is disposed in conduit 12a between inlet port 70 and branch conduit 12c and a remotely controllable valve 74 is disposed in conduit 12c between conduit 12a and inlet port 67, as illustrated. Valves 72 and 74 may be operated by a suitable data recorder and controller 76 operably associated with a CPU 76a. Valves 72 and 74 are operated in conjunction with each other to direct fluid flow from the aforementioned source to flow meter bodies 62 or 64, as required for operation of the flow meter in accordance with the invention.

Flow meter 60 includes mass flow sensors 24, 32 and 38 interposed in conduits 82, 84 and 86, respectively, in communication with conduits 78 and 80. Conduits 78 and 80, as shown, extend between and are in fluid flow communication with passages 66 and 68 of the flow meter 60. Conduits 82, 84 and 86 extend between conduit 78 and 80, as illustrated, and incorporate the mass flow sensors 24, 32 and 38 therein, respectively. Remotely controllable shutoff valves 88 and 90 are operably connected to data recorder and controller 76 and are interposed in conduit 78, as illustrated. Shut-off valve 88 is disposed between passage 68 and mass flow sensors 24, 32 and 313 while shut-off valve 90 is disposed between passage 66 and the aforementioned mass flow sensors.

The mass flow meters 10 and 60, shown in FIGS. 1 and 2, are operable to be valved in series with each mass flow controller, not shown, to be used as a reference to detect a calibration shift in the associated mass flow controller while operating on an inert gas, such as nitrogen, which would be indicative of a calibration shift also to be experienced by the same mass flow controller when operating on a process gas. The desired accuracy over the entire dynamic measurement range of a mass flow controller is assured by the use of redundant sets of mass flow sensors and associated flow restrictors or LFEs as shown for the mass flow meter of FIG. 1 or a set of mass flow sensors may be alternately associated with a particular flow restrictor or LFE, as for the flow meter 60 of FIG. 2.

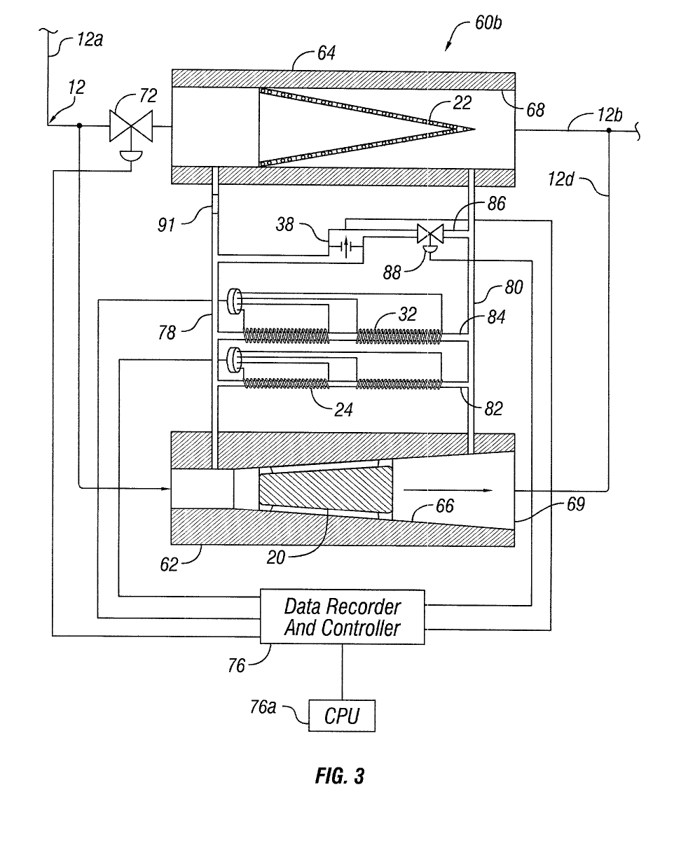

Referring now to FIG. 3, still another embodiment of a thermal sensor based flow meter is illustrated and generally designated by the numeral 60b. The flow meter 60b utilizes a substantial number of components of the flow meter 60 except for elimination of the remotely controllable valves in conduit 78 which interconnects the bodies 62 and 64. Remotely controllable valve 88 is shown moved to a position disposed in conduit 86 between conduit 80 and mass flow sensor 38. Alternatively, a flow restrictor or LFE 91 is shown interposed in conduit 78 at the approximate former location of valve 88. Still further, in the arrangement of the mass flow meter 60b, valve 74 has been eliminated. Valve 72 may be controlled to shut off flow through the body 64 at relatively low flow conditions and remotely controllable valve 88 is operable to close to shut off flow through the sensor 38 to avoid subjecting the sensor 38 to flow conditions at relatively high differential pressures across that sensor. Accordingly, a substantially wide range of fluid flows through the flow meter 60b may be accurately recorded thanks to the arrangement of the bodies 62 and 64, the flow restrictors or LFEs 20 and 22 and the sensors 24, 32 and 38, together with the control elements 72 and 88. Of course, all of the flow meter embodiments described herein are pre-calibrated so that the mass flows being sensed by the respective sensors can be correlated with the total flow through the meter for whatever flow paths are available for such flow to pass through the respective meters.

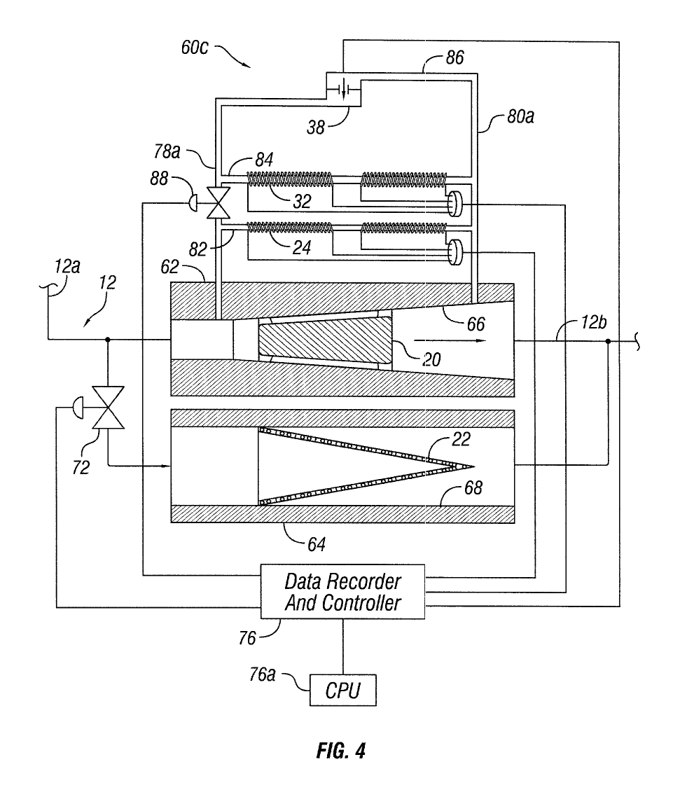

Referring now to FIG. 4, still another embodiment of a thermal sensor based flow meter is illustrated and generally designated by the numeral 60c. The flow meter 60c is similar in some respects to the flow meters 60 and 60b but enjoys a different arrangement of the bodies 62 and 64 and the sensors 24, 32 and 38. For operations at relatively high flow rates, all flow is directed through body 62 and passage 66 as well as only flow sensor 24 by actuating valves 72 and 88 to shut off flow through body 64 as well as through flow sensors 32 and 38. This operating mode is carried out primarily due to the non-linearity of sensor 38 at higher flow rates. As shown in FIG. 4, the sensors 24, 32 and 38 are arranged in their respective conduits 82, 84 and 86 which interconnect conduits 78a and 80a. Valve 88 is interposed sensors 24 and 32 to shut off flow to the sensors 32 and 38 at the aforementioned high flow conditions. Under such conditions valve 72 is also closed.

Other non-thermal based sensors may be capable of use with the flow meters of the invention. Differential pressure transducers, such as Honeywell Inc.'s model PPT1C, could be used with appropriately different flow restrictions therein, or accuracy and stability may be obtained also using a Model 698AA13TRA sensor available from MKS, Andover, Mass. or by using a piezo-electric based pressure transducer or transducers. However, the last mentioned type of mass flow sensor may present a significant cost disadvantage.

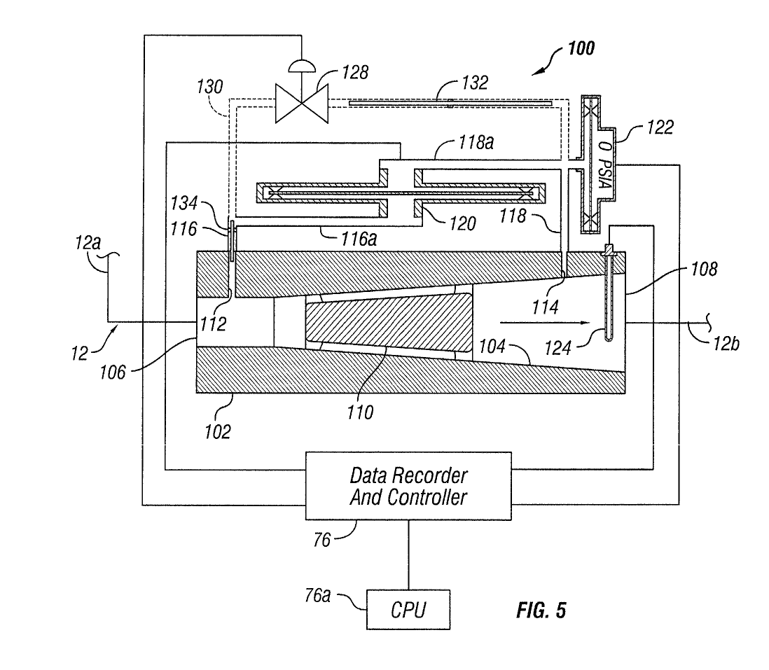

Referring now to FIG. 5, another embodiment of a mass flow meter in accordance with the invention is illustrated and generally designated by the numeral 100. The flow meter 100 is also adapted to be disposed in a conduit 12 between conduit sections 12a and 12b and includes a body 102 having a diverging flow passage 104 formed therein and in communication with an inlet port 106 and a discharge 108. Conduit section 12a is connected to inlet port 106 and conduit section 12b is connected to discharge port 108. A flow restrictor or LFE 110 is suitably disposed in passage 104 between lateral branch ports 112 and 114. Ports 112 and 114 are connected to conduits 116 and 118 which are in communication with a differential pressure type transducer 120 having a wide dynamic range, and suitably connected via a conduit section 118a to a suitable absolute pressure reference device 122. Transducer 120 is also connected to conduit 116 by branch conduit 116a. A suitable temperature sensor 124 is supported on body 102 for measuring the temperature of fluid flowing through passage 104, as indicated. Differential pressure transducer 120 may be of a type commercially available, such as a model 600 series, manufactured by MKS of Andover, Mass. Output signals from the transducer 120 are communicated to a data recorder and controller 76 which is also operable to operate a flow control valve 128 which may be connected to conduits 116 and 118 by a branch conduit 130, as shown. Conduit 130 also includes a suitable flow restrictor or LFE 132 disposed therein. A third LFE or flow restrictor 134 may be disposed in conduit 116, as shown in the schematic diagram of FIG. 5, upstream of transducer 120.

If the dynamic measurement range of the pressure transducer 120 is desired to be relatively low, flow restrictors 134 and 132 together with flow control valve 128 may be arranged as indicated in FIG. 5. Flow restrictor 134 is adapted to provide a markedly higher flow resistance than the flow resistance of restrictor 132, on the order of about twenty times greater, for example. By positioning the flow restrictor or LFE 134 upstream of the pressure transducer 120 and positioning the flow restrictor or LFE 132 as indicated in FIG. 3, a pressure divider is provided to shift the pressure differential seen by the transducer 120 when the valve 128 is open. When valve 128 is closed the pressure divider effect disappears.

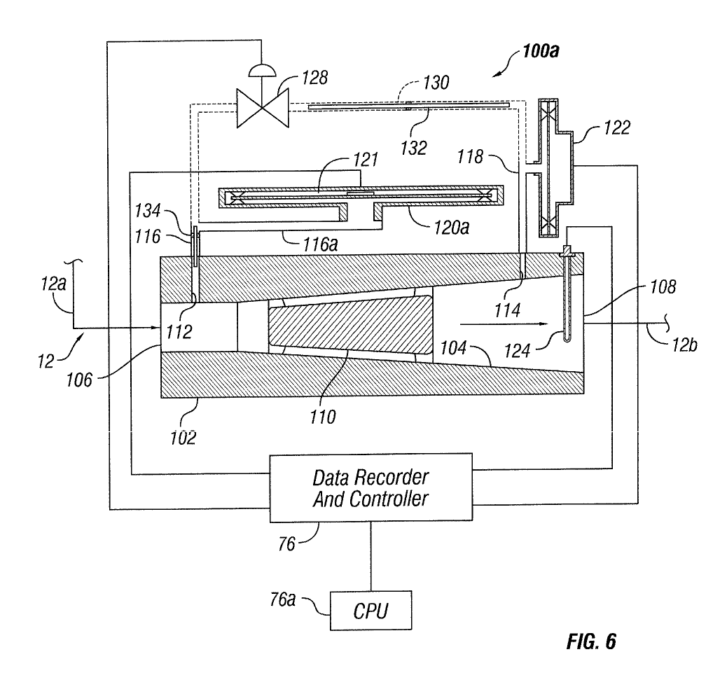

Referring now to FIG. 6, another embodiment of a pressure sensor based flow meter is illustrated and generally designated by the numeral 10a. The flow meter 100a utilizes the body 102, the annular plug type flow restrictor 110 and all of the other elements indicated in FIG. 6 which correspond to the same elements of FIG. 5 and the flow meter 100. However, the flow meter 100a includes a pressure transducer 120a having an absolute pressure reference chamber 121 formed therein. In this way the flow meter 100a may be interposed in conduits handling corrosive or otherwise hazardous gases since such gases will not act on both sides of the sensor or its diaphragm for the transducer 120a.

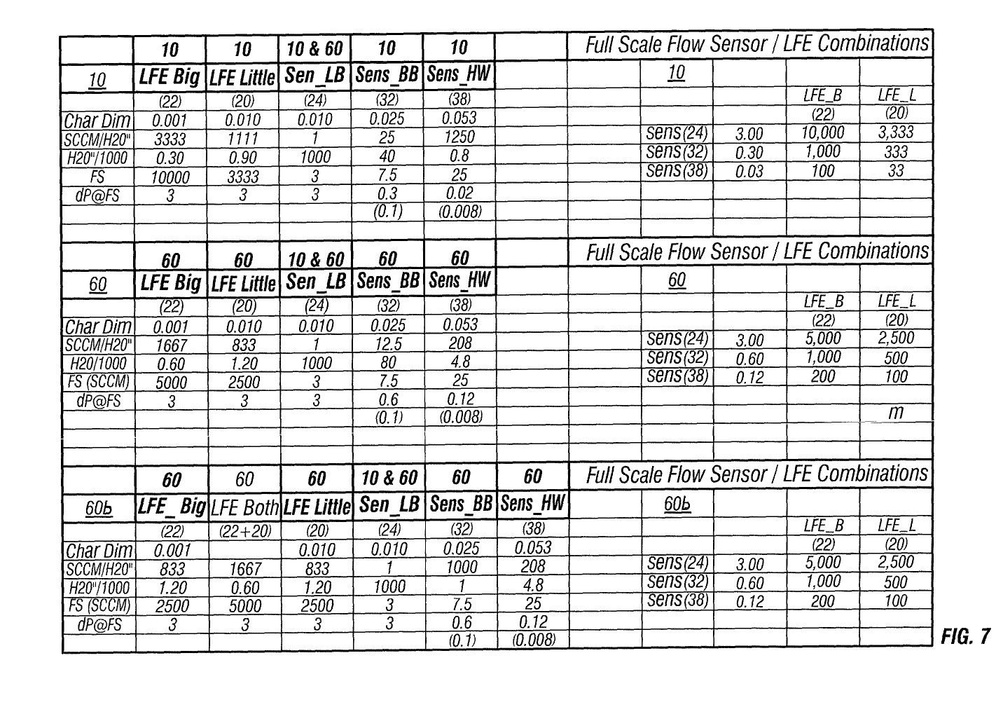

FIG. 7 is a table of certain design characteristics for the flow meter embodiments of FIGS. 1, 2 and 3. The parameters “CHAR DIM” refer to the effective bore or hydraulic diameters of the respective LFEs and sensors. The terms SEN_LB, SEN_BB and SEN_HW refer to the respective sensors 24, 32 and 38, as indicated in FIG. 7. The term FS refers to full scale flow in SCCM and the term dP@FS refers to the differential pressure across the element indicated in inches of water at full scale flow.

The construction and operation of the embodiments of the invention shown and described is believed to be within the purview of one skilled in the art based on the foregoing description read in conjunction with the drawings. Conventional materials and fabrication methods used for flow meters and flow controllers for gases used in semiconductor fabrication may be used to construct the flow meters described herein. Although preferred embodiments of the invention have been described in detail herein those skilled in the art will recognize that various substitutions and modifications may be made without departing from the scope and spirit of the appended claims.

What is claimed is:

1. A fluid mass flow meter, particularly useful in measuring fluid mass flow in a gas process system, said flow meter comprising:
a body including a passage extending therethrough and adapted to be in fluid flow receiving communication with a source of process fluid;
a flow restrictor disposed in said passage;
a first set of plural fluid mass flow sensors in fluid flow communication with said passage, each of said fluid mass flow sensors having a full scale flow measurement range capability different from each of the other fluid mass flow sensors for measuring fluid mass flow over a substantial range of fluid mass flow rates for fluid flowing through said flow meter.

2. The flow meter set forth in claim 1 wherein:
at least one of said mass flow sensors is a thermal mass flow sensor.

3. The flow meter set forth in claim 2 wherein:
said flow meter includes three mass flow sensors, each of said mass flow sensors having a full scale flow measurement range different from the other of said mass flow sensors.

4. The flow meter set forth in claim 2 wherein:
all of said mass flow sensors are thermal mass flow sensors.

5. The flow meter set forth in claim 3 wherein:
the full scale flow measurement range of each of said mass flow sensors overlaps a portion of the full scale flow measurement range of at least one other mass flow sensor in said flow meter.

6. The flow meter set forth in claim 1 including:
a second flow restrictor disposed in said passage in said body downstream of the first mentioned flow restrictor and a second set of plural mass flow sensors in fluid flow receiving communication with conduits connected to said body for measuring fluid mass flow through said flow meter.

7. The flow meter set forth in claim 6 wherein:
each of said plural mass flow sensors of said second set includes a full scale fluid flow operating range which overlaps at least a portion of the full scale mass flow measurement range of at least one other mass flow sensor of said second set.

8. The flow meter set forth in claim 7 wherein:
at least one of said mass flow sensors of said second set is a thermal mass flow sensor.

9. The flow meter set forth in claim 1 wherein:
the full scale flow measurement ranges of one of said mass flow sensors varies by a factor of at least two times the full scale flow measurement range of another mass flow sensor of said flow meter.

10. The flow meter set forth in claim 1 including:
a second body including a passage therein and a second flow restrictor disposed in said passage in said second body, said second body and said first body being operable to be in fluid flow receiving communication with said source;
conduit means interconnecting said bodies and in fluid flow communication with said mass, flow sensors; and
flow control valve means for controlling fluid flow through one or both of said bodies.

11. The flow meter set forth in claim 10 including:
flow control valve means for controlling fluid flow through said mass flow sensors from a selected one of said bodies.

12. The flow meter set forth in claim 10 including:
flow control valve means for selectively controlling fluid flow through at least one of said mass flow sensors.

13. The flow meter set forth in claim 10 wherein:
said first flow restrictor and said second flow restrictor are selected from a group consisting of a plug forming an annular flow path in said passage in said first body or said second body and a wire mesh member.

14. A fluid mass flow meter for use in measuring mass flow of a fluid to a process, said flow meter comprising:
a body including a passage therethrough, said body being adapted to be connected to a source of pressure gas at one end of said passage;
a first flow restrictor disposed in said passage;
a fluid mass flow sensor in fluid flow communication when said passage for measuring fluid mass flow through said flow meter, said mass flow sensor including a first conduit in communication with said passage on one side of said first flow restrictor and a second conduit in communication with said passage on an opposite side of said first flow restrictor and a second flow restrictor interposed in one of said conduits.

15. The flow meter set forth in claim 14 including:
a third flow restrictor disposed in said one of said conduits.

16. The flow meter set forth in claim 15 wherein:
said second flow restrictor has a greater fluid flow restriction than said third flow restrictor.

17. The flow meter set forth in claim 16 wherein:
the flow restriction characteristics of said second flow restrictor are about twenty times greater than the flow restriction characteristics of said third flow restrictor.

18. The flow meter set forth in claim 16 wherein:
said second flow restrictor is disposed upstream of said mass flow sensor.

19. The flow meter set forth in claim 16 wherein:
said third flow restrictor is disposed downstream of said mass flow sensor.

20. The flow meter set forth in claim 16 including:
a flow control valve interposed said second flow restrictor and said third flow restrictor.

21. The flow meter set forth in claim 16 wherein:
said fluid mass flow sensor comprises a differential pressure transducer.

22. A fluid mass flow meter for measuring flow of a gaseous fluid, said flow meter comprising:
a body including a passage therethrough, said body being adapted to be connected to a source of pressure gas at one end of said passage;
a flow restrictor disposed in said passage;
a fluid mass flow sensor including conduit means connected to said passage on opposite sides of said flow restrictor with respect to the direction of fluid flow through said passage, said fluid mass flow sensor including a pressure transducer for sensing one of a differential pressure across said flow restrictor and the pressure of fluid in said passage upstream of said flow restrictor, respectively.

23. The flow meter set forth in claim 22 including:
a temperature sensor for sensing the temperature of fluid flowing through said passage.

24. The flow meter set forth in claim 22 wherein:
said pressure transducer comprises a differential pressure transducer connected to said conduit means for measuring a differential pressure across said flow restrictor and said mass flow sensor includes an absolute pressure reference device for sensing the absolute pressure in said passage downstream of said flow restrictor.

25. The flow meter set forth in claim 24 including:
flow restriction means disposed in said conduit means and providing a pressure divider to modify the pressure differential seen by said pressure transducer.

26. The flow meter set forth in claim 25 wherein:
said flow restriction means includes a first flow restriction disposed in said conduit means between said passage and a branch conduit connected to said conduit means and said pressure transducer and a second flow restriction disposed in said conduit means between said first branch conduit and a second branch conduit connected to said conduit means and said pressure transducer.

27. The flow meter set forth in claim 26 including:
shutoff valve means disposed in said conduit means between said first flow restriction and said second flow restriction.

28. The flow meter set forth in claim 22 wherein:
said fluid mass flow sensor includes a pressure transducer for measuring the absolute pressure of fluid in said passage upstream of said flow restrictor and said fluid mass flow sensor includes an absolute pressure reference device for measuring the absolute pressure of fluid in said passage downstream of said flow restrictor.

29. The flow meter set forth in claim 28 including:
flow restriction means disposed in said conduit means and providing a pressure divider to modify the pressure seen by said pressure transducer.

30. The flow meter set forth in claim 29 wherein:
said flow restriction means includes a first flow restriction disposed in said conduit means between said passage and a branch conduit connected to said conduit means and said pressure transducer and a second flow restriction disposed in said conduit means between said first branch conduit and a second branch conduit connected to said pressure reference device.

31. The flow meter set forth in claim 30 including:
shutoff valve means disposed in said conduit means between said first flow restriction and said second flow restriction.

32. A fluid mass flow meter, particularly useful in measuring fluid mass flow in a gas process system, said flow meter comprising:
a first body including a first passage extending therethrough and operable to be in fluid flow receiving communication with a source of process fluid;
a second body including a second passage extending therethrough and adapted to be in fluid flow receiving communication with said source of process fluid;
first and second flow restrictors disposed in said first and second passages, respectively;
plural fluid mass flow sensors operable to be in fluid flow communication with said first and second passages, said mass flow sensors having predetermined full scale flow measurement ranges, respectively, for measuring fluid mass flow over a substantial range of fluid flow rates through said flow meter, said fluid mass flow sensors each being operably connected to a first conduit operable to be in fluid flow communication with said passages upstream of said first and second flow restrictors and said fluid mass flow sensors being operably connected to a second conduit operable to be in fluid flow communication with said passages at a point downstream of said first and second flow restrictors.

33. The flow meter set forth in claim 32 including:
a flow control valve operable to direct fluid flow from said source to one or both of said first and second passages.

34. The flow meter set forth in claim 32 including:
a flow control valve operably associated with said flow meter for shutting off fluid flow through at least one of said fluid mass flow sensors while permitting fluid flow through at least another of said fluid mass flow sensors.

35. The flow meter set forth in claim 32 including:
a third flow restrictor disposed in one of said conduits between said plural mass flow sensors and one of said first and second passages.

36. The flow meter set forth in claim 32 wherein:
at least one of said fluid mass flow sensors is a thermal fluid mass flow sensor.

37. The flow meter set forth in claim 36 wherein:
each of said fluid mass flow sensors is a thermal mass flow sensor.
